(19) United States
(12) Patent Application Publication
(10) Pub. No.: US 2020/0086719 A1
(43) Pub. Date: Mar. 19, 2020

(54) REFRIGERATION CYCLE APPARATUS

(71) Applicant: DENSO CORPORATION, Kariya-city (JP)

(72) Inventors: Maro MIDORIKAWA, Kariya-city (JP); Hisashi IEDA, Kariya-city (JP)

(21) Appl. No.: 16/692,690

(22) Filed: Nov. 22, 2019

Related U.S. Application Data
(63) Continuation of application No. PCT/JP2018/020232, filed on May 25, 2018.

(30) Foreign Application Priority Data
Jun. 8, 2017 (JP) 2017-113656

(51) Int. Cl. B60H 1/32; G05D 1/00

(52) U.S. Cl. CPC B60H 1/3208; G05D 2201/0213; B60H 2001/3242; G05D 1/0088

(57) ABSTRACT

A refrigeration cycle apparatus is mounted in a vehicle and has a circulation circuit through which a refrigerant circulates. The apparatus includes a refrigerant amount calculating unit and an operating state determining unit. The refrigerant amount calculating unit acquires a physical quantity and calculates an amount of the refrigerant. The operating state determining unit determines, based on traveling conditions of the vehicle, whether the vehicle is in an operating state in which the refrigerant circulating in the circulation circuit becomes a stable state. The refrigerant amount calculating unit calculates the amount of the refrigerant when the operating state determining unit determines that the vehicle is in the operation state.

### CROSS REFERENCE TO RELATED APPLICATIONS

This application is a continuation application of international Patent Application No. PCT/JP2018/020232 filed on May 25, 2018, which designated the U.S. and claims the benefit of priority from Japanese Patent Application No. 2017-113656 filed on Jun. 8, 2017. The entire disclosure of the above application is incorporated herein by reference.

### TECHNICAL FIELD

The present disclosure relates to a refrigeration cycle apparatus that is mounted in a vehicle and includes a circulation circuit through which a refrigerant circulates.

### BACKGROUND ART

There is a refrigeration cycle apparatus used for air conditioning for houses. This refrigeration cycle apparatus includes a circulating circuit through which a refrigerant flows and a temperature thermistor that detects a temperature of the refrigerant in each part of the circulation circuit. Further, the refrigeration cycle apparatus includes an input/calculation/determination unit that controls the refrigeration cycle based on each detection value detected by each temperature thermistor, and a display unit that displays the output from the input/calculation/determination unit.

### SUMMARY

According to one aspect of the present disclosure, a refrigeration cycle apparatus is mounted in a vehicle and has a circulation circuit through which a refrigerant circulates. The apparatus may include a refrigerant amount calculating unit that acquires a physical quantity for specifying a refrigerant amount of the refrigerant that circulates in the circulation circuit. The refrigerant amount calculating unit calculates the refrigerant amount of the refrigerant that circulates in the circulation circuit based on the physical quantity. The apparatus may further include an operating state determining unit that is configured to determine, based on traveling conditions of the vehicle, whether the vehicle is in an operating state in which the refrigerant circulating in the circulation circuit becomes a stable state. The refrigerant amount calculating unit is configured to calculate the refrigerant amount of the refrigerant when the operating state determining unit determines that the vehicle is in the operation state in which the refrigerant circulating in the circulation circuit becomes the stable state.

### BRIEF DESCRIPTION OF DRAWINGS

The above and other objects, features and advantages of the present disclosure will become more apparent from the following detailed description made with reference to the accompanying drawings.

FIG. 1 is a schematic diagram of a vehicle in which a refrigeration cycle apparatus is mounted according to a first embodiment.

FIG. 2 is an overall configuration diagram of the refrigeration cycle apparatus according to the first embodiment.

FIG. 3 is a Mollier diagram showing a state of the refrigerant in the refrigeration cycle apparatus.

FIG. 4 is an overall configuration diagram of the refrigeration cycle apparatus according to the first embodiment.

FIG. 5 is a flowchart executed by a refrigerant leak detecting device according to the first embodiment.

FIG. 6 is a diagram showing an example of a route to a destination.

FIG. 7 is a diagram showing a curve of a speed when a vehicle travels along a route to a destination.

FIG. 8 is a flowchart of a refrigerant amount determination process executed by the refrigerant leak detecting device.

FIG. 9 is a flowchart executed by the refrigerant leak detecting device according to a second embodiment.

FIG. 10 is a diagram for explaining a determination process of a vehicle speed.

FIG. 11 is a flowchart executed by the refrigerant leak detecting device according to a third embodiment.

### DESCRIPTION OF EMBODIMENTS

Hereinafter, embodiments of the present disclosure will be described with reference to the drawings. In the following embodiments, parts, which are the same as or equivalent to those described in the preceding embodiments, will be indicated by the same reference signs, and the description thereof may be omitted. In addition, when only a part of components is described in the embodiment, the components described in the preceding embodiment can be applied to other parts of the components. The respective embodiments described herein may be partially combined with each other as long as no particular problems are caused even without explicit statement of these combinations.

In a refrigeration cycle apparatus, an input/calculation/determination unit compares the measured value of the amount of the liquid phase refrigerant in the outside heat exchanger with a theoretical value. When the refrigerant is filled, the refrigeration cycle apparatus automatically determines a proper amount of the refrigerant and displays a refrigerant filled state on the display unit.

As described above, a refrigeration cycle apparatus for air conditioning for houses or buildings uses a hermetic type compressor. Each pipe of the refrigeration cycle apparatus is joined by welding, and therefore substantially no refrigerant leak occurs.

On the other hand, in a refrigeration cycle apparatus mounted in a moving body such as a vehicle, it is necessary to use a semi-hermetic or open type compressor for convenience of maintenance. Furthermore, it is necessary to use rubber pipes in a part of the circulation circuit of the refrigeration cycle apparatus in order to absorb vibration generated during movement of the moving body. In this type of refrigeration cycle apparatus, a small amount of refrigerant leaks from the compressor or pipes inevitably happens. Therefore, it has been desired that the amount of refrigerant circulating in the pipes can be detected with high accuracy.

Further, in the refrigeration cycle apparatus mounted in a moving body such as a vehicle, the state of the refrigeration cycle is greatly affected by traveling conditions of the vehicle. For example, in such a refrigeration cycle apparatus, the rotational speed of the compressor varies depending on the rotational speed of the engine. That is, the state of the refrigerant circulating in the circulation circuit greatly varies by the rotational speed of the engine. Moreover, in such a refrigeration cycle apparatus, the traveling wind introduced into a radiator greatly varies by the vehicle speed. That is, the state of the refrigerant circulating in the circulation circuit also greatly varies by the vehicle speed. In this way, it is difficult to accurately detect the amount of the refrigerant circulating in each pipe under the situation where the refrigerant state greatly fluctuates.

In view of this, the timing for detecting the refrigerant amount may be restricted only to a state where the refrigerant circulating in the circulation circuit is stable, for example. Under this state, the refrigerant amount may be detected when a passenger operates a detection button. However, this process requires the passenger to take a triggering action, which would make the passenger feel annoying. Further, if the detection button is not operated by a passenger, the refrigerant amount cannot be detected.

An objective of the present disclosure is to, in a refrigeration cycle apparatus mounted in a vehicle, enable accurate detection of the amount of the refrigerant circulating in a circulation circuit without requiring an operation by a passenger.

According to an aspect of the present disclosure, when the operating state determining unit determines that the refrigerant circulating in the circulation circuit is in a stable state, the refrigerant amount calculating unit calculates a refrigerant amount of the refrigerant. Thus, in a refrigeration cycle apparatus mounted in a vehicle, it is possible to enable accurate detection of the amount of the refrigerant circulating in a circulation circuit without requiring an operation by a passenger.

### First Embodiment

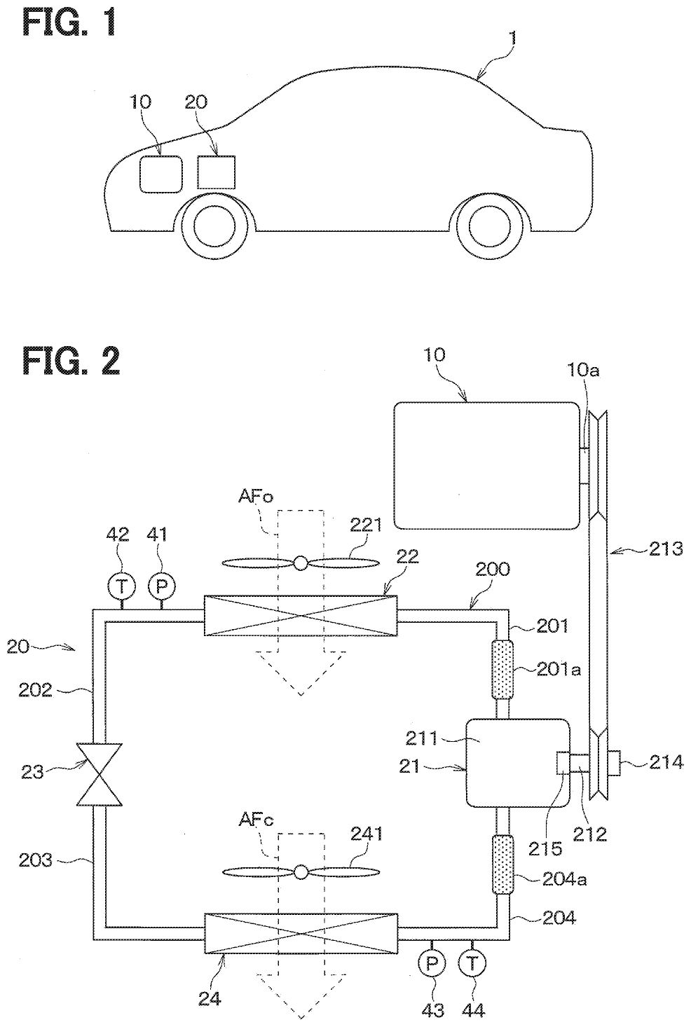

The present embodiment will be described with reference to FIGS. 1 to 8. As shown in FIG. 1, in the present embodiment, a refrigeration cycle apparatus 20 is mounted in an autonomous driving vehicle 1 which is a moving body. The vehicle 1 of this embodiment is equipped with an engine 10 that functions as a driving source for traveling of the vehicle and for the refrigeration cycle apparatus 20.

The refrigeration cycle apparatus 20 is applied to a vehicle air conditioner that conditions air in the interior space of the vehicle 1. The refrigeration cycle apparatus 20 functions to cool air blown into the vehicle interior space until it reaches a target temperature.

As shown in FIG. 2, the refrigeration cycle apparatus 20 is configured as a vapor compression type refrigeration cycle system. The refrigeration cycle apparatus 20 includes a circulation circuit 200 in which a refrigerant circulates, a compressor 21, a radiator 22, a decompression device 23, and an evaporator 24.

The refrigeration cycle apparatus 20 uses R134a, an HFC refrigerant, as a refrigerant. The refrigerant is mixed with oil that serves as a lubricant in the compressor 21. Part of the oil circulates in the circulation circuit 200 together with the refrigerant.

The compressor 21 is a device that sucks a refrigerant and compresses and discharges the refrigerant. The compressor 21 may include a reciprocating type compression mechanism. Alternatively, the compressor 21 may include a rotary type compression mechanism.

The compressor 21 of the present embodiment is driven by a rotational driving force output from an external engine 10. The compressor 21 of this embodiment is an open type compressor. Specifically, in the compressor 21 of this embodiment, a shaft 212 that outwardly protrudes through a housing 211 is connected to an output shaft 10a of the engine 10 via a power transmission mechanism 213 such as a pulley and a belt. As a result, the shaft 212 is rotated by the driving force from the engine 10.

Further, the compressor 21 of the present embodiment is provided with an electromagnetic clutch 214 that turns on/off transmission of the rotational driving force from the engine 10. The compressor 21 of this embodiment stops when the electromagnetic clutch 214 is turned off.

In the compressor 21 of the present embodiment, a portion where the shaft 212 passes through the housing 211 is sealed by a seal member 215 such as a mechanical seal or a lip seal. The seal member 215 is made of a polymer material containing resin. The polymer material has gas permeability. For this reason, in the compressor 21, the refrigerant in the housing 211 may gradually permeate outside through the seal member 215.

The radiator 22 is a heat exchanger. The radiator 22 radiates a heat through heat exchanging between a high-temperature and high-pressure refrigerant discharged from the compressor 21 and an outside air introduced by an outdoor blower 221 or an outside air introduced by the ram pressure generated when the vehicle 1 is running. The radiator 22 of the present embodiment is disposed at a front side of the engine compartment where an outside air is introduced by the ram pressure when the vehicle 1 is traveling. The refrigerant flowing into the radiator 22 is condensed through heat exchange with the outside air. Note that the outside air passes through the radiator 22 as indicated by a broken line arrow AFo in FIG. 2.

The decompression device 23 is an expansion valve that decompresses and expands the refrigerant that has passed through the radiator 22. As the decompression device 23, for example, a temperature type expansion valve capable of adjusting a temperature of the refrigerant at an outlet side of the evaporator 24 to a predetermined temperature is used.

The evaporator 24 is a heat exchanger. In the evaporator 24, the low-temperature and low-pressure refrigerant decompressed by the decompression device 23 evaporates through heat exchange with a blown air supplied by an inside blower 241 to the vehicle interior. The blown air supplied by the inside blower 241 passes through the evaporator 24 as indicated by a broken line arrow AFc in FIG. 2. The blown air supplied from the inside blower 241 is cooled to a desired temperature by latent heat of vaporization of the refrigerant when passing through the evaporator 24. Thereafter, the blown air is blown into the vehicle interior.

The circulation circuit 200 is a closed circuit formed by connecting the compressor 21, the radiator 22, the decompression device 23, and the evaporator 24 through a plurality of pipes 201 to 204. Specifically, the circulation circuit 200 includes a first high-pressure pipe 201 and a second high-pressure pipe 202. The first high-pressure pipe 201 connects a refrigerant outlet side of the compressor 21 and a refrigerant inlet side of the radiator 22. The second high-pressure pipe 202 connects a refrigerant outlet side of the radiator 22 and a refrigerant inlet side of the decompression device 23. The circulation circuit 200 further includes a first low-pressure pipe 203 and a second low-pressure pipe 204. The first low-pressure pipe 203 connects a refrigerant outlet side of the decompression device 23 and a refrigerant inlet side of the evaporator 24. The second low-pressure pipe 204 connects a refrigerant outlet side of the evaporator 24 and a refrigerant suction side of the compressor 21.

The high-pressure pipes 201 and 202 and the low-pressure pipes 203 and 204 are basically metal pipes. However, the first high-pressure pipe 201 includes a first polymer pipe 201a. The first polymer pipe 201a includes polymer material (for example, rubber or resin) having high flexibility to absorb vibrations of the engine 10 and the compressor 21. Similarly, the second low-pressure pipe 204 has a second polymer pipe 204a. The second polymer pipe 204a includes polymer material (for example, rubber or resin) having high flexibility to absorb vibrations of the engine 10 and the compressor 21.

Each of the polymer pipes 201a and 204a has high gas permeability as compared with the other metal parts. For this reason, the refrigerant flowing through each polymer pipe 201a, 204a may gradually permeate to an outside from the polymer pips 201a, 204a. In particular, since the high-pressure refrigerant compressed by the compressor 21 flows through the first polymer pipe 201a, the refrigerant relatively easily leaks to the outside.

In the refrigeration cycle apparatus 20 of the present embodiment, a slow leak of the refrigerant from the seal member 215 of the compressor 21 or the polymer pipes 201a, 204a inevitably occurs. Thus, the refrigeration cycle apparatus 20 includes a refrigerant leak detecting device 30 to detect such refrigerant leakage.

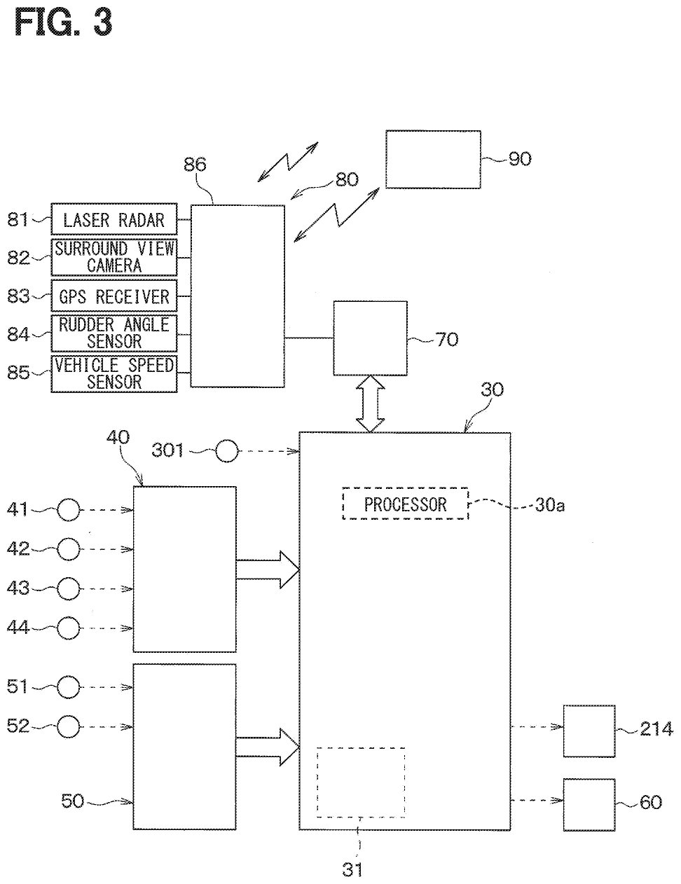

The refrigerant leak detecting device 30 shown in FIG. 3 includes a microcomputer having a processor 30a and a storage unit 31 such as ROM, RAM, or flash memory, and its peripheral circuits. Each element of the storage unit 31 is a non-transitory tangible storage medium.

As shown in FIG. 3, the refrigerant leak detecting device 30 is connected to an outside air temperature sensor 301 that detects an outside air temperature, an air conditioning controlling device 40 that controls the refrigeration cycle apparatus 20, and an engine controlling device 50 that controls the engine 10.

The refrigerant leak detecting device 30 is connected to the air conditioning controlling device 40 and the engine controlling device 50. Then, air conditioning control information included in the air conditioning controlling device 40 and travel control information included in the engine controlling device 50 are transmitted to the refrigerant leak detecting device 30.

The air conditioning controlling device 40 is connected to various sensors that detect a temperature and a pressure of the refrigerant flowing through the circulation circuit 200. Specifically, a high-pressure side pressure sensor 41 that detects a pressure of the high-pressure refrigerant that has flowed out of the radiator 22 and a high-pressure side temperature sensor 42 that detects a temperature of the high-pressure refrigerant are connected to the air conditioning controlling device 40. The air-conditioning controlling device 40 is connected to a low-pressure side pressure sensor 43 that detects a pressure of the low-pressure refrigerant that has flowed out of the evaporator 24 and a low-pressure side temperature sensor 44 that detects a temperature of the low-pressure refrigerant.

The refrigerant leak detecting device 30 of the present embodiment obtains, as the air conditioning control information, information detected by each of the high pressure side pressure sensor 41, the high pressure side temperature sensor 42, the low pressure side pressure sensor 43, and the low pressure side temperature sensor 44 from the air conditioning controlling device 40.

The engine controlling device 50 is connected to a rotational speed sensor 51 that detects rotational speeds of the engine 10, a vehicle speed sensor 52 that detects traveling speeds of the vehicle 1, and the like. The refrigerant leak detecting device 30 of the present embodiment acquires, as engine control information, information detected by each of the rotational speed sensor 51 and the vehicle speed sensor 52 from the engine controlling device 50.

In the refrigeration cycle apparatus 20, the compressor 21 is driven by the rotational driving force output from the engine 10. Hence, the rotational speed of the engine 10 greatly affects operating conditions of the compressor 21 of the refrigeration cycle apparatus 20.

Further, in the refrigeration cycle apparatus 20, outside air is introduced into the radiator 22 by the ram pressure when the vehicle 1 is travelling. Therefore, the traveling speed of the vehicle 1 affects a heat radiation amount of the radiator 22 in the refrigeration cycle apparatus 20.

The refrigerant leak detecting device 30 is connected to an electromagnetic clutch 214 of the compressor 21, a notification device 60 that notifies a user of abnormality, and the like. Although not shown, the notification device 60 has a display panel that visually displays various abnormality information regarding the refrigeration cycle device 20. The notification device 60 displays information indicating abnormal leakage on the display panel when an abnormal signal indicating abnormal refrigerant leakage is input from the refrigerant leakage detecting device 30. Note that the notification device 60 is not necessarily limited to a device that visually notifies abnormality information, and may notify such abnormality information audibly.

The refrigerant leak detecting device 30 is connected to a communication device 70 mounted in the vehicle 1. The communication device 70 can communicate with an autonomous driving control device 80 that performs an autonomous driving.

The autonomous driving control device 80 includes a laser radar 81, a surround view camera 82, a GPS receiver 83, a rudder angle sensor 84, a vehicle speed sensor 85, and a control unit 86. The autonomous driving control device 80 is connected to the laser radar 81, the surround view camera 82, the GPS receiver 83, the rudder angle sensor 84, the vehicle speed sensor 85, and so on.

The laser radar 81 transmits a laser light to a specified range around the subject vehicle and receives the reflected light. The laser radar 81 detects existence of an object and the distance from the vehicle 1 to a reflection point, and outputs the distance to the control unit 86.

The surround view camera 82 captures an image of an area extending to a specified angular range around the vehicle 1, and outputs image signals to the control unit 86. The GPS receiver 83 receives a radio wave from a GPS artificial satellite and outputs information (latitude/longitude information) specifying the current location, which is included in the radio wave, to the control unit 86.

The rudder angle sensor 84 detects a steering angle of a steering of the vehicle 1. A position of the steering at which the vehicle moves straight is defined as a neutral position (0 degree), and the rudder angle sensor 84 is configured to output, as the steering angle, a rotational angle from the neutral position to the control unit 86. The vehicle speed sensor 85 outputs a vehicle speed signal in accordance with the rotational speed of each wheel to the control unit 86.

The control unit 86 is a computer having a CPU, RAM, ROM, flash memory, and I/O. The CPU performs various types of processing according to programs stored in the ROM. The control unit 86 specifies the current position of the vehicle 1 and the direction of the vehicle 1 based on signals input from the sensors. The RAM, ROM, and flash memory of the control unit 86 are non-transitional physical storage media.

The flash memory of the control unit 86 stores route information of routes to a plurality of predetermined destinations. The route information includes link identification information, link location information, link type information, link road type information (that is, type information such as an expressway, a vehicle dedicated road, an ordinary road, and a narrow local street), a traveling speed, node identification information, node location information, node type information, connection information indicating a connection relationship between a node and a link, information indicating whether a traffic signal exists at the node, traffic signal location information, and the like.

The control unit 86 reads out route information to one destination selected from the plurality of destinations from the flash memory, and performs autonomous driving based on the route information. Specifically, the control unit 86 adjusts an acceleration opening, the steering angle, the brake pressure, and the like by transmitting an instruction signal to each ECU of the vehicle 1. Then, the control unit 86 performs autonomous driving so that the vehicle 1 travels along the route, while adjusting the vehicle speed of the vehicle 1 to a preset target value.

The control unit 86 performs wireless communication with a server 90 installed in an operation managing center or the like, and transmits operating conditions of the vehicle 1, abnormality in the vehicle, and the like to the server 90. In addition, the control unit 86 changes the destination and the route in response to instructions from the server 90, or stores traffic jam information transmitted from the server 90 in the RAM.

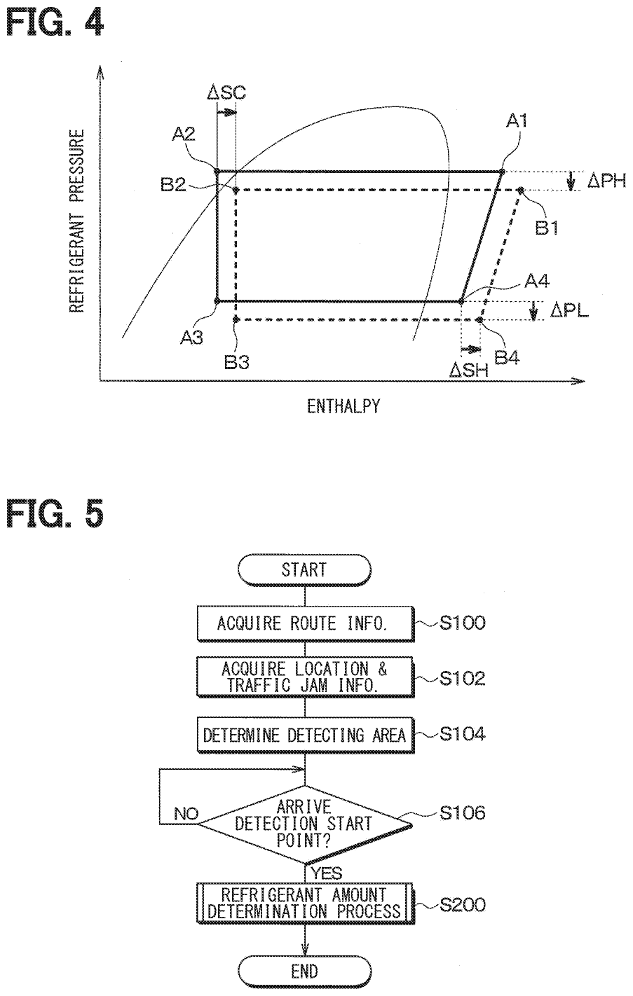

Next, the operation of the refrigeration cycle apparatus 20 of the present embodiment will be described with reference to FIG. 4. When the vehicle air conditioner is started while the engine 10 is running, the air conditioning controlling device 40 turns on the electromagnetic clutch 214 to operate the compressor 21.

Thereby, as shown by the solid line in FIG. 4, the refrigerant discharged from the compressor 21 (that is, the point A1 in FIG. 4) flows into the radiator 22. The refrigerant radiates heat through heat exchange with an outside air at the radiator 22 (that is, point A1->point A2 in FIG. 4).

The refrigerant that has flowed out of the radiator 22 (that is, point A2 in FIG. 4) flows into the decompressing device 23 and is decompressed and expanded until it reaches a predetermined pressure in the decompressing device 23 (that is, point A2->A3 in FIG. 4).

The refrigerant that has flowed out of the decompressing device 23 (that is, the point A3 in FIG. 4) flows into the evaporator 24. Then, the refrigerant evaporates in the evaporator 24 by absorbing heat from the air blown into the vehicle interior (i.e., point A3->point A4 in FIG. 4). As a result, the air blown into the vehicle interior is cooled. Then, the refrigerant flowing out of the evaporator 24 (that is, point A4 in FIG. 4) flows toward the suction side of the compressor 21 and is compressed again by the compressor 21 (that is, point A4->A1 in FIG. 4).

Here, in the refrigeration cycle apparatus 20, when the refrigerant amount in the circulation circuit 200 decreases, the pressure of the low-pressure refrigerant sucked into the compressor 21 decreases as shown by the broken line in FIG. 4. Moreover, superheat degree SH of the refrigerant at the outlet side of the evaporator 24 increases (i.e., A4 point->B4 point of FIG. 4).

Further, when the pressure of the refrigerant sucked into the compressor 21 is decreased due to decrease in the refrigerant amount, the pressure of the high-pressure refrigerant discharged from the compressor 21 is also decreased. Moreover, supercooling degree SC of the refrigerant at the outlet side of the radiator 22 decreases (that is, point A2->point B2 in FIG. 4).

Thus, in the refrigeration cycle apparatus 20, there is a strong correlation between the refrigerant amount in the circulation circuit 200 and the temperature and pressure of the refrigerant in the circulation circuit 200.

Next, a specific refrigerant leak detection process executed by the processor 30a of the refrigerant leak detecting device 30 according to the present embodiment will be described. The refrigerant leak detection device 30 (i.e., the processor 30a) periodically performs the process shown in FIG. 5 when the engine 10 of the vehicle 1 is in operation. Each control step of the control process shown in FIG. 5 constitutes a function block that realizes each function executed by the refrigerant leakage detecting device 30.

At step S100, the refrigerant leak detecting device 30 acquires route information to the destination. Specifically, the refrigerant leak detecting device 30 requests the control unit 86 of the autonomous driving control device 80 to transmit route information to the destination. In response to this transmission request, route information from the control unit 86 to the destination is transmitted to the refrigerant leak detecting device 30. The route information includes link identification information, link location information, link type information, and link road type information (that is, type information such as an expressway, a vehicle dedicated road, a normal road, and a narrow local street).

Next, the refrigerant leak detecting device 30 acquires location information of the vehicle 1 and traffic jam information at step S102. Specifically, the refrigerant leak detecting device 30 requests the control unit 86 of the autonomous driving control device 80 to transmit the location information of the vehicle 1 and traffic jam information. In response to this transmission request, the location information (for example, latitude/longitude information) of the vehicle 1 and the traffic jam information are transmitted from the control unit 86 to the refrigerant leak detecting device 30.

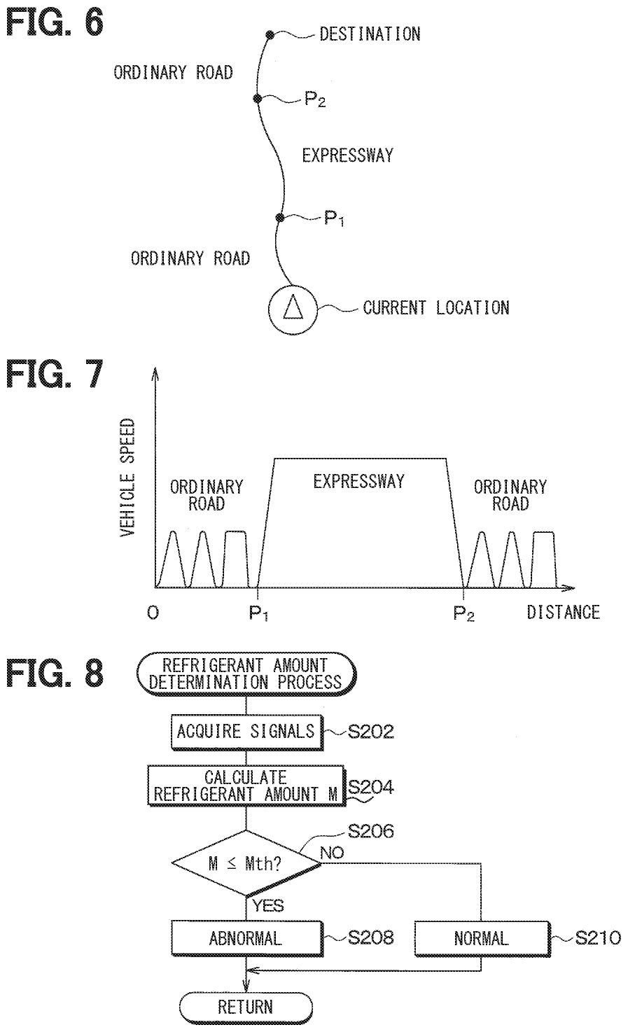

Next, the refrigerant leak detecting device 30 determines a refrigerant amount detection area at step S104. Here, it is assumed that the route to the destination includes an expressway as shown in FIG. 6. Specifically, the route to the destination passes through a normal road from the current location and then enters the expressway from an entrance P1 of the expressway. Then, the route to the destination reaches the destination through another normal road at an exit P2 of the expressway.

Here, a point away from the entrance P1 of the expressway by a specified distance (for example, 2 kilometers) toward the exit P2 of the expressway is set as a refrigerant amount detection start point. Here, the refrigerant amount detection start point is set as a point at which the vehicle 1 would be in an operating state where the refrigerant circulating in the circulation circuit 200 becomes a stable state.

In particular, in the autonomous driving vehicle 1 that is not affected by passenger's accelerator operation, the rotational speed of the engine 10 of the vehicle 1 usually becomes constant at a point away from the entrance P1 of the expressway by a specified distance (for example, 2 kilometers). Therefore, as shown in FIG. 7, the vehicle speed also becomes constant, and traveling wind introduced into the radiator 22 is also substantially constant. As a result, it is highly likely that the state of the refrigerant circulating in the circulation circuit 200 becomes a stable state when the vehicle reaches that point. Thus, the refrigerant leak detecting device 30 sets such a point as the refrigerant amount detection point.

In contrast in normal roads, there is a high possibility that the vehicle 1 repeatedly stops and starts depending on states of traffic lights. Hence, it is not preferable to set a point on such a road as the refrigerant amount detection point because the refrigerant circulating in the circulation circuit 200 is not likely stable.

Next, at step S106, the refrigerant leak detecting device 30 determines whether the vehicle is in an operating state in which the refrigerant circulating in the circulation circuit 200 is in a stable state based on whether or not the vehicle 1 has reached the refrigerant amount detection point. If the vehicle 1 has not reached the refrigerant amount detection start point, the determination at S106 is repeated. When the vehicle 1 reaches the refrigerant amount detection start point and the vehicle is in the operating state, the refrigerant amount determination process is performed at S200.

However, when it is determined that traffic congestion has occurred on the expressway based on traffic jam information, the vehicle 1 might not be in such an operating state in which the refrigerant circulating in the circulation circuit 200 is in a stable state. In this case, the refrigerant leakage detecting device 30 determines that the vehicle is not in the operating state in which the refrigerant circulating in the circulation circuit 200 is in the stable state.

A flowchart of the refrigerant amount determination process at S200 is shown in FIG. 8. In the refrigerant amount determination process, the refrigerant leakage detecting device 30 acquires each signal at S202. In the present embodiment, the refrigerant leak detection device 30 obtains a refrigerant temperature x1 detected by the low-pressure side temperature sensor 44, a refrigerant pressure x2 detected by the low-pressure side pressure sensor 43, a rotational speed x3 of the engine 10, and a vehicle speed x4 of the vehicle 1.

At the next S204, a refrigerant amount M is estimated by multiple regression analysis. Specifically, the refrigerant temperature detected by the low pressure side temperature sensor 44 is defined as x1, the refrigerant pressure detected by the low pressure side pressure sensor 43 is defined as x2, the rotation speed of the engine 10 is defined as x3, and the vehicle speed of the automobile 1 is defined as x4. Then, the refrigerant leak detecting device 30 calculates the refrigerant amount M using the function f (x1, x2, x3, x4). That is, it can be calculated as M=f (x1, x2, x3, x4).

At next S206, the refrigerant leak detecting device 30 determines whether or not the refrigerant amount M calculated at S204 is equal to or less than a refrigerant threshold Mth. Here, when the refrigerant amount M is equal to or smaller than the refrigerant threshold value Mth, the refrigerant leakage detecting device 30 determines at S208 that the refrigerant amount is abnormal. Then, the refrigerant leak detecting device 30 notifies that the refrigerant amount is abnormal via the notifying device 60, and the process returns to the flowchart shown in FIG. 5. When the refrigerant amount M is greater than the refrigerant threshold Mth, the refrigerant leak detecting device 30 determines that the refrigerant amount is normal. Then, the refrigerant leak detecting device 30 notifies that the refrigerant amount is normal via the notifying device 60, and the process returns to the flowchart shown in FIG. 5.

As described above, the refrigeration cycle apparatus includes the circulation circuit 200 that is mounted in the vehicle 1 and in which the refrigerant circulates. In addition, the refrigeration cycle apparatus includes the refrigerant amount calculating unit (S200) that acquires a physical quantity such as the location information and the traffic jam information for specifying the amount of the refrigerant circulating in the circulation circuit, and calculates the refrigerant amount of the refrigerant circulating in the circulation circuit based on the physical quantity. In addition, the refrigeration cycle apparatus includes the operating state determining unit (S100 to S106) that determines whether or not the vehicle is in an operating state in which the refrigerant circulating in the circulation circuit is in a stable state. Then, when the operating state determining unit determines that the vehicle is in the operating state in which the refrigerant circulating in the circulation circuit is in the stable state, the refrigerant amount calculating unit calculates the refrigerant amount of the refrigerant circulating in the circulation circuit.

Accordingly, the refrigerant amount calculating unit calculates the refrigerant amount of the refrigerant circulating in the circulation circuit when the vehicle is determined to be in the operating state. Thus, in the refrigeration cycle apparatus mounted in a vehicle, it is possible to enable accurate detection of the amount of the refrigerant circulating in the circulation circuit without requiring an operation by a passenger.

Furthermore, the vehicle is an autonomous driving vehicle that travels automatically at a predetermined vehicle speed along a predetermined route. In addition, the operating state determination unit includes the travel determining unit (106) that determines whether the route on which the autonomous driving vehicle travels includes an expressway or a vehicle dedicated road and whether the autonomous driving vehicle is traveling on the expressway or the vehicle dedicated road included in the route on which the autonomous driving vehicle travels.

Then, the operating state determining unit is configured to determine that the vehicle is in the operation state in which the refrigerant circulating in the circulation circuit is in the stable state when the travel determining unit determines that the autonomous driving vehicle is traveling on the expressway or the vehicle dedicated road included in the route on which the autonomous driving vehicle travels.

As described above, when it is determined that the autonomous driving vehicle is traveling on an expressway or a vehicle dedicated road, it is determined that the autonomous driving vehicle is in the operating state, and the refrigerant amount of the refrigerant circulating in the circulation circuit can be calculated with high accuracy.

Even when the engine of the vehicle 1 is in an idling state for a predetermined period or more, the refrigerant circulating in the circulation circuit becomes a stable state. However, the load on the refrigeration cycle apparatus 20 increases when the vehicle is traveling on an expressway or a vehicle dedicated road. Therefore, the refrigerant amount of the refrigerant circulating in the circulation circuit can be calculated with higher accuracy when the vehicle is traveling on an expressway or a vehicle dedicated road.

The operating state determining unit is further configured to determine that the vehicle is not in the operating state in which the refrigerant circulating in the circulation circuit becomes the stable state even when the travel determining unit determines that the autonomous driving vehicle is traveling on an expressway or a vehicle dedicated road included in the route on which the autonomous driving vehicle travels if the operating state determining unit determines that a traffic congestion has occurred on the expressway or the vehicle dedicated road based on traffic information.

Therefore, the refrigerant amount of the refrigerant circulating in the circulation circuit is not calculated when there is a traffic congestion on the expressway or the vehicle dedicated road based on the traffic jam information.

Further, the refrigeration cycle apparatus includes the location information acquiring unit (S102) that is configured to acquire location information indicating a location of the autonomous driving vehicle, the travel determining unit is further configured to determine whether the autonomous driving vehicle is traveling on the expressway or the vehicle dedicated road based on the location information acquired by the location information acquiring unit.

In this way, the traveling determining unit can determine whether or not the autonomous driving vehicle is traveling on an expressway or a vehicle dedicated road based on the location information acquired by the location information acquiring unit.

### Second Embodiment

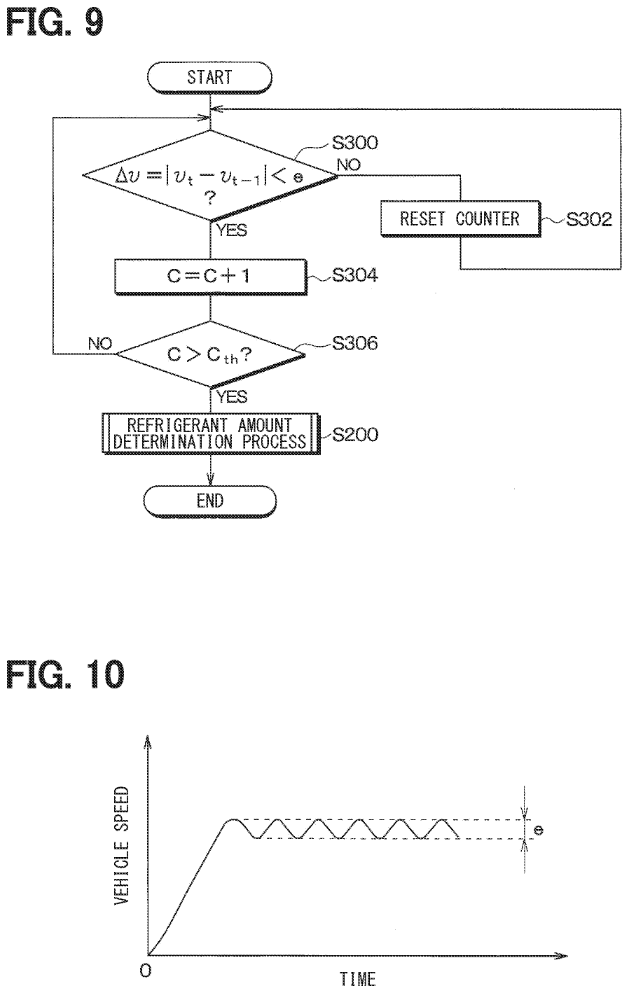

A refrigeration cycle apparatus 20 according to a second embodiment of the present disclosure will be described with reference to FIGS. 9 to 10. In the first embodiment, the refrigeration cycle apparatus 20 mounted in the autonomous driving vehicle 1. In the present embodiment, the refrigeration cycle apparatus 20 is mounted in an automobile that travels by an accelerator operation, brake operation, steering operation, or the like by a driver. Therefore, the vehicle 1 equipped with the refrigeration cycle apparatus 20 of the present embodiment is not equipped with the autonomous driving control device 80 shown in FIG. 3. The refrigeration cycle apparatus 20 of the present embodiment has the same configuration as that shown in FIGS. 1 to 2.

FIG. 9 shows a flowchart executed by the refrigerant leak detecting device (i.e., the processor) according to the present embodiment. The refrigerant leak detecting device 30 periodically performs the process shown in FIG. 9 when the engine 10 of the vehicle 1 is in operation.

First, at S300, the refrigerant leak detecting device 30 determines whether the difference Δv between a vehicle speed v of the vehicle 1 at the current time and a vehicle speed vt−1 at a single unit previous time is less than a specified value e (for example, 5 kilometers per hour). Initially, the vehicle speed vt−1 at a single previous time is set to zero. Here, when the vehicle speed v of the vehicle 1 is 0, Δv=0, and at S304, the refrigerant leak detecting device 30 changes the count value C to C+1.

At next S306, it is determined whether or not the count value C is greater than a count threshold Cth. If the count value C is equal to or less than the count threshold value Cth, the process returns to S300.

Here, it is assumed that the vehicle 1 starts traveling and, the vehicle speed v of the vehicle 1 is, for example, 10 kilometers per hour. In this case, since Δv=|v−vt−1|>e, the process proceeds to S302, and the refrigerant leakage detecting device 30 resets the counter and returns to S300.

In addition, it is assumed that the vehicle speed v of the vehicle 1 is 20 kilometers per hour. In this case, since Δv=|v−vt−1|>e, the process proceeds to S302, and the refrigerant leakage detecting device 30 resets the counter and returns to S300. These processes are repeated, and it is assumed that the vehicle speed v of the vehicle 1 is 100 kilometers per hour, and the vehicle speed vt−1 at an one previous time was also 100 kilometers per hour. In this case, as shown in FIG. 10, Δv=|v−vt−1|<e, and at S304, the refrigerant leak detecting device 30 changes the count value C to C+1.

At next S306, it is determined whether or not the count value C is greater than a count threshold Cth. If the count value C is equal to or less than the count threshold value Cth, the process returns to S300.

Thus, when the vehicle speed v of the vehicle 1 is maintained at about 100 km/h, Δv=|v−vt−1|<e continues for a predetermined period, and the count value C exceeds the count threshold Cth, the refrigerant leak detecting device 30 performs a refrigerant amount determination process at S200.

In other words, when it is determined that the vehicle is traveling continuously for a specified time period or more in a state where the vehicle speed is within a specified range based on the vehicle speed signal, the refrigerant amount determination process is performed at S200.

The present embodiment can achieve the effects and advantages, which are obtained from the structure common to the first embodiment.

The operating state determining unit includes the continuous travel determining unit that is configured to determine whether the vehicle is continuously traveling for a specified time period or more at a travel speed within a specified range based on a speed signal of the vehicle. Then, the operating state determining unit is further configured to determine that the vehicle is in the operation state in which the refrigerant circulating in the circulation circuit becomes the stable state when the continuous travel determining unit determines that the vehicle is continuously traveling for the specified time period or more at a travel speed within the specified range.

In this way, when it is determined that the vehicle is traveling continuously for a specified time period or more at a travel speed within a specified range based on the speed signal, the operating state determining unit can determine that the vehicle is in the operation state in which the refrigerant circulating in the circulation circuit becomes the stable state.

### Third Embodiment

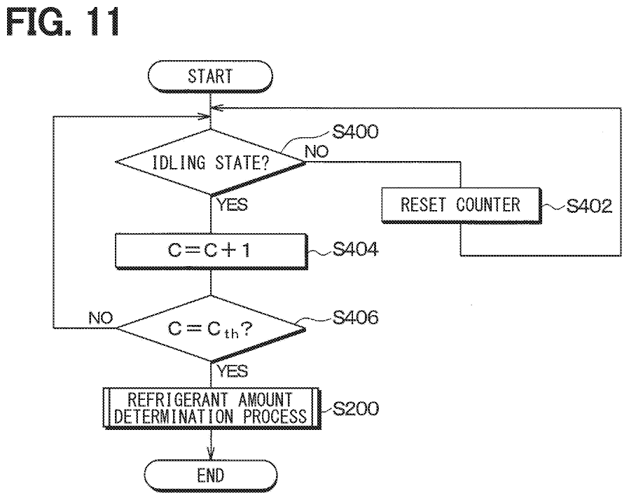

A refrigeration cycle apparatus 20 according to a third embodiment of the present disclosure will be described with reference to FIG. 11. In the present embodiment, the refrigeration cycle apparatus 20 is mounted in a normal automobile that travels by an accelerator operation, brake operation, steering operation, or the like by a driver. Therefore, the vehicle 1 equipped with the refrigeration cycle apparatus 20 of the present embodiment is not equipped with the autonomous driving control device 80 shown in FIG. 3. The refrigeration cycle apparatus 20 of the present embodiment has the same configuration as that shown in FIGS. 1 to 2.

FIG. 9 shows a flowchart executed by the refrigerant leak detecting device (i.e., the processor) according to the present embodiment. The refrigerant leak detecting device 30 periodically performs the process shown in FIG. 9 when the engine 10 of the vehicle 1 is in operation.

First, at S400, the refrigerant leak detecting device 30 determines whether the vehicle in an idling state of the engine based on the rotational speed of the engine 10 detected by the rotational speed sensor 51 and the vehicle speed signal output from the vehicle speed sensor 52. Specifically, when the rotational speed of the engine 10 is an idling rotational speed and the vehicle speed of the vehicle 1 is 0 km/h based on the vehicle speed signal, the engine of the vehicle 1 is determined to be in an idling state. Here, when the engine of the vehicle 1 is not in the idling state, at S402, the refrigerant leak detecting device 30 resets the counter and returns to S400.

When the engine of the vehicle 1 is in an idling state, the refrigerant leak detecting device 30 changes the count value C to C+1 at S404.

At next S406, the refrigerant leak detecting device 30 determines whether or not the count value C is greater than the count threshold Cth. If the count value C is equal to or less than the count threshold value Cth, the process returns to S400.

When the engine of the vehicle 1 maintains the idling state, the refrigerant leak detecting device 30 changes the count value C to C+1 at S404.

At next S406, the refrigerant leak detecting device 30 determines whether or not the count value C is greater than the count threshold Cth. If the count value C is equal to or less than the count threshold value Cth, the process returns to S400.

Such processes are repeatedly performed. Then, if the engine of the vehicle 1 is in the idling state continuously for the specified time period and the count value C exceeds the count threshold value Cth, a refrigerant amount determination process is performed at S200.

As described above, when it is determined that the engine 10 has been in an idling state continuously for a specified period or more, it is determined that the vehicle is in an operating state in which the refrigerant circulating in the circulation circuit is in a stable state. Then, the refrigerant amount determination process is performed.

The present embodiment can achieve the effects and advantages, which are obtained from the structure common to the first embodiment.

The vehicle includes the engine 10. The operating state determining unit includes an idling state determining unit that is configured to determine whether the engine 10 is continuously in an idling state for a specified time period or more. Then, the operating state determining unit is further configured to determine that the vehicle is in the operating state in which the refrigerant circulating in the circulation circuit becomes the stable state when the idling state determining unit determines that the engine is continuously in an idling state for the specified time period or more.

In this way, when it is determined that the engine has been in the idling state continuously for at least a specified time period, the vehicle is determined to be in the operating state in which the refrigerant circulating in the circulation circuit is in a stable state.

### OTHER EMBODIMENTS

(1) In each of the above embodiments, the refrigeration cycle apparatus 20 including the compressor 21 that is rotationally driven by the engine 10 is applied to a vehicle in which the engine 10 is mounted. However, the refrigeration cycle apparatus 20 may be applied to a vehicle such as an electric vehicle without an engine 10.

(2) In each of the above embodiments, the refrigerant amount M is estimated using the refrigerant temperature x1 detected by the low-pressure side temperature sensor 44, the refrigerant pressure x2 detected by the low-pressure side pressure sensor 43, the rotational speed x3 of the engine 10, and the vehicle speed x4 of the vehicle 1.

In addition to those, the refrigerant pressure detected by the high-pressure side pressure sensor 41, the refrigerant temperature detected by the high-pressure side temperature sensor 42, and the compressor capacity of the variable capacity compressor 21 specified based on signals from the air conditioning controlling device 40 may be used to estimate the refrigerant amount M.

Furthermore, the low-temperature and low-pressure refrigerant decompressed by the decompression device 23, the blower output of the inside blower 241 that blows air into the vehicle interior, the blower output of the outside blower 221 that introduces outside air into the radiator 22, and the rotational speed of the compressor 21 may be used to estimate the refrigerant amount M. Further, the refrigerant amount M may be estimated by selectively using one or more state quantities from these state quantities.

(3) In the first embodiment described above, the operating state determining unit 190 is configured to determine that the vehicle is in the operation state in which the refrigerant circulating in the circulation circuit 200 becomes the stable state when an expressway is determined to be included in the route on which the autonomous driving vehicle travels and the autonomous driving vehicle is determined to be traveling on the expressway.

On the contrary, the operating state determining unit 191 may be configured to determine that the autonomous driving vehicle is in the operation state in which the refrigerant circulating in the circulation circuit 200 is in the stable state when a vehicle dedicated road is determined to be included in the route on which the autonomous driving vehicle travels and the autonomous driving vehicle is determined to be traveling on the vehicle dedicated road.

(4) In the first embodiment, a point away from the entrance P1 of the expressway toward the exit P2 of the expressway by a predetermined distance (for example, 2 kilometers) is set as the refrigerant amount detection start point after entering the expressway from the entrance P1 of the expressway. However, a specified point on an expressway or vehicle dedicated road may be set as the refrigerant amount detection start point.

(5) In the first embodiment, location information indicating the current location of the autonomous driving vehicle is acquired, and it is determined whether or not the autonomous driving vehicle is traveling on an expressway or a vehicle dedicated road based on the location information.

Alternatively, information indicating whether or not the autonomous driving vehicle is traveling on an expressway is acquired as the location information, and then the operating state determining unit may determine whether the autonomous driving vehicle is traveling on an expressway or vehicle dedicated road based on the information indicating whether or not the autonomous driving vehicle is traveling on an expressway.

The present disclosure is not limited to the above-described embodiments, and can be appropriately modified. Individual elements or features of a particular embodiment are generally not limited to that particular embodiment, but, where applicable, are interchangeable and can be used in a selected embodiment, even if not specifically shown or described. In each of the embodiments described above, it is needless to say that the elements configuring the embodiment are not necessarily indispensable except when it is clearly indicated that the elements are particularly indispensable, when the elements are clearly considered to be indispensable in principle, and the like. A amount, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. The material, the shape, the positional relationship, and the like of a component or the like mentioned in the above embodiments are not limited to those being mentioned unless otherwise specified, limited to specific material, shape, positional relationship, and the like in principle, or the like.

(Overview)

According to a first aspect shown as one part or the entire part in the above-described embodiments, the refrigeration cycle apparatus is mounted in a vehicle (1), and has a circulation circuit (200) through which a refrigerant circulates. The refrigeration cycle apparatus includes a refrigerant amount calculating unit (S200) that acquires a physical quantity for specifying a refrigerant amount of the refrigerant that circulates in the circulation circuit, the refrigerant amount calculating unit calculating the refrigerant amount of the refrigerant that circulates in the circulation circuit based on the physical quantity.

Further, an operating state determining unit (S100 to S106, S300, S400) that determines whether the vehicle is in an operating state in which the refrigerant circulating in the circulation circuit becomes a stable state is included.

Then, the refrigerant amount calculating unit is configured to calculate the refrigerant amount of the refrigerant when the operating state determining unit determines that the vehicle is in the operation state in which the refrigerant circulating in the circulation circuit becomes the stable state.

According to a second aspect shown as one part or the entire part in the above-described embodiments, the vehicle is an autonomous driving vehicle that travels automatically at a predetermined vehicle speed along a predetermined route.

In addition, the operating state determination unit includes the travel determining unit (S106) that determines whether the route on which the autonomous driving vehicle travels includes an expressway or a vehicle dedicated road and whether the autonomous driving vehicle is traveling on the expressway or the vehicle dedicated road included in the route on which the autonomous driving vehicle travels.

Then, the operating state determining unit is configured to determine that the vehicle is in the operation state in which the refrigerant circulating in the circulation circuit becomes the stable state when the travel determining unit determines that the autonomous driving vehicle is traveling on the expressway or the vehicle dedicated road included in the route on which the autonomous driving vehicle travels.

In this way, the operating state determining unit is configured to determine that the vehicle is in the operation state in which the refrigerant circulating in the circulation circuit becomes the stable state when the travel determining unit determines that the autonomous driving vehicle is traveling on the expressway or the vehicle dedicated road included in the route on which the autonomous driving vehicle travels.

According to a third aspect shown as one part or the entire part in the above-described embodiments, the operating state determining unit is further configured to determine that the vehicle is not in the operation state in which the refrigerant circulating in the circulation circuit becomes the stable state even when the travel determining unit determines that the autonomous driving vehicle is traveling on an expressway or a vehicle dedicated road included in the route on which the autonomous driving vehicle travels if the operating state determining unit determines that a traffic congestion has occurred on the expressway or the vehicle dedicated road based on traffic information.

In this way, when it is determined that traffic congestion has occurred on the expressway or the vehicle dedicate road based on traffic jam information, the autonomous driving vehicle is not determined to be in an operating state in which the refrigerant circulating in the circulation circuit 200 is in a stable state. Therefore, it is possible to avoid calculating the refrigerant amount of the refrigerant circulating in the circulation circuit.

According to a fourth aspect shown as one part or the entire part in the above-described embodiments, a location information acquiring unit (S102) that is configured to acquire location information indicating a location of the autonomous driving vehicle is included. Then, the travel determining unit is further configured to determine whether the autonomous driving vehicle is traveling on the expressway or the vehicle dedicated road based on the location information acquired by the location information acquiring unit.

In this way, the traveling determining unit can determine whether or not the autonomous driving vehicle is traveling on an expressway or a vehicle dedicated road based on the location information acquired by the location information acquiring unit.

According to a fifth aspect shown as one part or the entire part in the above-described embodiments, the operating state determining unit includes a continuous travel determining unit (S300) that is configured to determine whether the vehicle is continuously traveling for a specified time period or more at a travel speed within a specified range based on a speed signal of the vehicle.

Then, the operating state determining unit is further configured to determine that the vehicle is in the operation state in which the refrigerant circulating in the circulation circuit becomes the stable state when the continuous travel determining unit determines that the vehicle is continuously traveling for the specified time period or more at a travel speed within the specified range.

In this way, the operating state determining unit can determine that the vehicle is in the operation state in which the refrigerant circulating in the circulation circuit becomes the stable state when the continuous travel determining unit determines that the vehicle is continuously traveling for the specified time period or more at a travel speed within the specified range.

According to a sixth aspect shown as one part or the entire part in the above-described embodiments, the vehicle includes an engine (10). The operating state determining unit includes an idling state determining unit (S400) that is configured to determine whether the engine is continuously in an idling state for a specified time period or more.

Then, the operating state determining unit determines that the vehicle is in the operating state in which the refrigerant circulating in the circulation circuit becomes the stable state when the idling state determining unit determines that the engine is continuously in an idling state for the specified time period or more.

In this way, the operating state determining unit can determine that the vehicle is in the operating state in which the refrigerant circulating in the circulation circuit becomes the stable state when the idling state determining unit determines that the engine is continuously in an idling state for the specified time period or more.

In the above embodiments, the process by the processor 30a at S200 may be a corresponding structure of the refrigerant amount calculating unit, and the process by the processor 30a at S100 to S106, S300, and S400 may be a corresponding structure of the operating state determining unit. Furthermore, the process by the processor 30a at S106 may be a corresponding structure of the travel determining unit, the process by the processor 30a at S102 may be a corresponding structure of the location information acquiring unit, the process by the processor 30a at S300 may be a corresponding structure of the continuous travel determining unit, and the process by the processor 30a at S400 may be a corresponding structure of the idling state determining unit.

1. A refrigeration cycle apparatus mounted in a vehicle and having a circulation circuit through which a refrigerant circulates, the apparatus comprising:
a refrigerant amount calculating unit that is configured to acquire a physical quantity and calculate an amount of the refrigerant that circulates in the circulation circuit based on the physical quantity; and
an operating state determining unit that is configured to determine, based on traveling conditions of the vehicle, whether the vehicle is in an operating state in which the refrigerant circulating in the circulation circuit becomes a stable state, wherein
the refrigerant amount calculating unit calculates the amount of the refrigerant when the operating state determining unit determines that the vehicle is in the operation state in which the refrigerant circulating in the circulation circuit becomes the stable state.

2. The refrigeration cycle apparatus according to claim 1, wherein the vehicle is an autonomous driving vehicle that travels automatically at a predetermined speed along a predetermined route,
the operating state determining unit includes a travel determining unit that is configured to:
determine whether the route on which the autonomous driving vehicle travels includes an expressway or a vehicle dedicated road; and
determine whether the autonomous driving vehicle is traveling on the expressway or the vehicle dedicated road, wherein
the operating state determining unit is configured to determine that the vehicle is in the operation state in which the refrigerant circulating in the circulation circuit becomes the stable state when the travel determining unit determines that the autonomous driving vehicle is traveling on the expressway or the vehicle dedicated road.

3. The refrigeration cycle apparatus according to claim 2, wherein
the operating state determining unit is further configured to determine that the vehicle is not in the operation state in which the refrigerant circulating in the circulation circuit becomes the stable state even when the travel determining unit determines that the autonomous driving vehicle is traveling on the expressway or the vehicle dedicated road included in the route on which the autonomous driving vehicle travels if the operating state determining unit determines that a traffic congestion has occurred on the expressway or the vehicle dedicated road based on traffic jam information.

4. The refrigeration cycle apparatus according to claim 2, further comprising
a location information acquiring unit that is configured to acquire location information indicating a location of the autonomous driving vehicle, wherein
the travel determining unit is further configured to determine whether the autonomous driving vehicle is traveling on the expressway or the vehicle dedicated road based on the location information acquired by the location information acquiring unit.

5. The refrigeration cycle apparatus according to claim 1, wherein
the operating state determining unit includes a continuous travel determining unit that is configured to determine whether the vehicle is continuously traveling for at least a specified time period at a speed within a specified range based on a speed signal of the vehicle, and
the operating state determining unit is further configured to determine that the vehicle is in the operation state in which the refrigerant circulating in the circulation circuit becomes the stable state when the continuous travel determining unit determines that the vehicle is continuously traveling for at least the specified time period at a speed within the specified range.

6. The refrigeration cycle apparatus according to claim 1, wherein
the vehicle includes an engine,
the operating state determining unit includes an idling state determining unit that is configured to determine whether the engine is continuously in an idling state for at least a specified time period, and
the operating state determining unit is further configured to determine that the vehicle is in the operating state in which the refrigerant circulating in the circulation circuit becomes the stable state when the idling state determining unit determines that the engine is continuously in an idling state for at least the specified time period.

7. A refrigeration cycle apparatus mounted in a vehicle and having a circulation circuit through which a refrigerant circulates, the apparatus comprising
a processor programmed to:
acquire a physical quantity and calculate an amount of the refrigerant that circulates in the circulation circuit based on the physical quantity; and
determine, based on traveling conditions of the vehicle, whether the vehicle is in an operating state in which the refrigerant circulating in the circulation circuit becomes a stable state, wherein
the processor is programmed to calculate the amount of the refrigerant upon determining that the vehicle is in the operation state in which the refrigerant circulating in the circulation circuit becomes the stable state.

8. The refrigeration cycle apparatus according to claim 7, wherein
the vehicle is an autonomous driving vehicle that travels automatically at a predetermined speed along a predetermined route,
the processor is further programmed to:
determine whether the route on which the autonomous driving vehicle travels includes an expressway or a vehicle dedicated road and whether the autonomous driving vehicle is traveling on the expressway or the vehicle dedicated road; and
determine that the vehicle is in the operation state in which the refrigerant circulating in the circulation circuit becomes the stable state upon determining that the autonomous driving vehicle is traveling on the expressway or the vehicle dedicated road.

9. The refrigeration cycle apparatus according to claim 8, wherein
the processor is further programmed to determine that the vehicle is not in the operation state in which the refrigerant circulating in the circulation circuit becomes the stable state even when that the autonomous driving vehicle is determined to be traveling on the expressway or the vehicle dedicated road included in the route on which the autonomous driving vehicle travels if the processor determines that a traffic congestion has occurred on the expressway or the vehicle dedicated road based on traffic jam information.

10. The refrigeration cycle apparatus according to claim 8, wherein
the processor is further programmed to:
acquire location information indicating a location of the autonomous driving vehicle; and
determine whether the autonomous driving vehicle is traveling on the expressway or the vehicle dedicated road based on the location information acquired by the location information acquiring unit.

11. The refrigeration cycle apparatus according to claim 7, wherein
the processor is further programmed to:
determine whether the vehicle is continuously traveling for at least a specified time period at a speed within a specified range based on a speed signal of the vehicle; and
determine that the vehicle is in the operation state in which the refrigerant circulating in the circulation circuit becomes the stable state upon determining that the vehicle is continuously traveling for at least the specified time period at a speed within the specified range.

12. The refrigeration cycle apparatus according to claim 7, wherein
the vehicle includes an engine, and
the processor is further programmed to:
determine whether the engine is continuously in an idling state for at least a specified time period; and
determine that the vehicle is in the operating state in which the refrigerant circulating in the circulation circuit becomes the stable state upon determining that the engine is continuously in an idling state for at least the specified time period.
